(19) United States
(12) Patent Application Publication
(10) Pub. No.: US 2021/0187742 A1
(43) Pub. Date: Jun. 24, 2021

(54) CONTROL DEVICE AND CONTROL METHOD

(71) Applicant: FANUC CORPORATION, Minamitsuru-gun (JP)

(72) Inventor: Shinichi OZEKI, Yamanashi (JP)

(21) Appl. No.: 17/112,067

(22) Filed: Dec. 4, 2020

(30) Foreign Application Priority Data
Dec. 20, 2019 (JP) 2019-230097

(51) Int. Cl. B25J 9/16; B25J 11/00; B25J 13/00

(52) U.S. Cl. CPC B25J 9/1674; B25J 13/006; B25J 11/005; B25J 9/161

(57) ABSTRACT

To reliably execute processing of a client or application to be prioritized according to processing contents for each processing state for an industrial machine. A control device relates to a control device that executes processing of processing requests for an industrial machine from a plurality of clients, the control device including: a priority determination unit configured to determine, in a case in which a plurality of the processing requests is received from the plurality of clients, a priority of each of the plurality of clients according to a processing state of the industrial machine, and a processing switching unit configured to switch an order of processing of each of the plurality of the processing requests based on a priority of each of the plurality of clients determined by the priority determination unit.

This application is based on and claims the benefit of priority from Japanese Patent Application 2019-230097, filed on 20 Dec. 2019, the content of which is incorporated herein by reference.

### BACKGROUND OF THE INVENTION

### Field of the Invention

The present invention relates to a control device and a control method.

### Related Art

Among control devices for controlling an industrial machine, there are control devices which include a server that communicates with a plurality of clients such as a display device and a tablet and, in response to a processing request from each of the plurality of clients to the control device, perform processing relating to the industrial machine. In this case, conventionally, the control device executes the processing relating to the industrial machine in the order of the processing request received from each of the plurality of clients.

In this regard, a technique has been known for communication between a general client and a server, in which a priority is set in advance for each client to be communicated, and the communication is performed based on the priority that was set. For example, see Patent Document 1.

Patent Document 1: Japanese Unexamined Patent Application, Publication No. H7-143147

### SUMMARY OF THE INVENTION

However, if the priority is set uniformly for each client in the control device for controlling the industrial machine, when giving a machine tool as an example of the industrial machine, the client or application that is desired to be prioritized differs depending on the processing state of the machine tool (for example, during machining (MEM mode), EDIT mode, etc.). Therefore, the control device may not always be able to perform the processing to be performed immediately, depending on the processing state of the machine tool.

Therefore, it has been desired to reliably execute processing of a client or application to be prioritized according to processing contents for each processing state for an industrial machine.

An aspect of a control device according to the present disclosure relates to a control device that executes processing of processing requests for an industrial machine from a plurality of clients, the control device including: a priority determination unit configured to determine, in a case in which a plurality of the processing requests is received from the plurality of clients, a priority of each of the plurality of clients according to a processing state of the industrial machine, and a processing switching unit configured to switch an order of processing of each of the plurality of the processing requests based on a priority of each of the plurality of clients determined by the priority determination unit.

An aspect of a control method according to the present disclosure relates to a control method for executing processing of processing requests for an industrial machine from a plurality of clients, the method including: determining, in a case in which a plurality of the processing requests is received from the plurality of clients, a priority of each of the plurality of clients according to a processing state of the industrial machine; and switching an order of processing of each of the plurality of processing requests based on a priority of each of the plurality of clients.

According to one aspect, it is possible to reliably execute processing of a client or application to be prioritized according to processing contents for each processing state for an industrial machine.

### BRIEF DESCRIPTION OF THE DRAWINGS

FIG. 1 is a functional block diagram showing a functional configuration example of a control system according to an embodiment;

FIG. 2A is a diagram showing an example of a terminal priority table when a processing state of a machine tool is in the MEM mode (during machine operation) or the MDI mode (during machine operation);

FIG. 2B is a diagram showing an example of a terminal priority table when the processing state of the machine tool is the JOG mode (during machine operation) or the HND mode (during machine operation);

FIG. 2C is a diagram showing an example of a terminal priority table when the processing state of the machine tool is the MEM mode (during machine non-operation), the MDI mode (during machine non-operation), the JOG mode (during machine non-operation), or the HND mode (during machine non-operation);

FIG. 2D is a diagram showing an example of a terminal priority table when the processing state of the machine tool is the EDIT mode (during machine non-operation);

FIG. 3A is a diagram showing an example of an application priority table when the processing state of the machine tool is the MEM mode (during machine operation) or the MDI mode (during machine operation);

FIG. 3B is a diagram showing an example of an application priority table when the processing state of the machine tool is the JOG mode (during machine operation) or the HND mode (during machine operation);

FIG. 3C is a diagram showing an example of an application priority table when the processing state of the machine tool is the MEM mode (during machine non-operation), the MDI mode (during machine non-operation), the JOG mode (during machine non-operation), or the HND mode (during machine non-operation);

FIG. 3D is a diagram showing an example of an application priority table when the processing state of the machine tool is the EDIT mode (during machine non-operation);

FIG. 4A is a diagram showing an example in which two clients execute one application, and communicate with a server of a numerical control device to process a processing request;

FIG. 4B is a diagram showing an example in which one client executes two applications, and communicates with the server of the numerical control device to process a processing request;

FIG. 4C is a diagram showing an example in which two clients execute two applications, and communicate with the server of the numerical control device to process a processing request;

FIG. 5 is a diagram showing an example in which two clients are disposed;

FIG. 6 is a diagram showing an example of switching an order of NC processing for a plurality of processing requests based on the priority of clients and the priority of applications in the case of FIG. 4C;

FIG. 7 is a flowchart for explaining the control processing of a numerical control device;

FIG. 8 is a functional block diagram showing a functional configuration example of a control system;

FIG. 9A is a diagram showing an example of a terminal priority table when the processing state of a robot is the automatic operation (MEM) mode (during robot operation);

FIG. 9B is a diagram showing an example of a terminal priority table when the processing state of the robot is the automatic operation (MEM) mode (during robot non-operation);

FIG. 10A is a diagrams showing an example of an application priority table when the processing state of the robot is the automatic operation (MEM) mode (during robot, operation); and

FIG. 10B is a diagram showing an example of the application priority table when the processing state of the robot is the automatic operation (MEM) mode (during robot non-operation).

### DETAILED DESCRIPTION OF THE INVENTION

Hereinafter, a description will be given of an embodiment of the present disclosure with reference to the drawings. Herein, a machine tool is exemplified as an industrial machine, and a numerical control device is exemplified as a control device. It should be noted that the present invention is not limited to a machine tool, and may be applicable to, for example, an industrial robot, a service robot, or the like.

### Embodiments

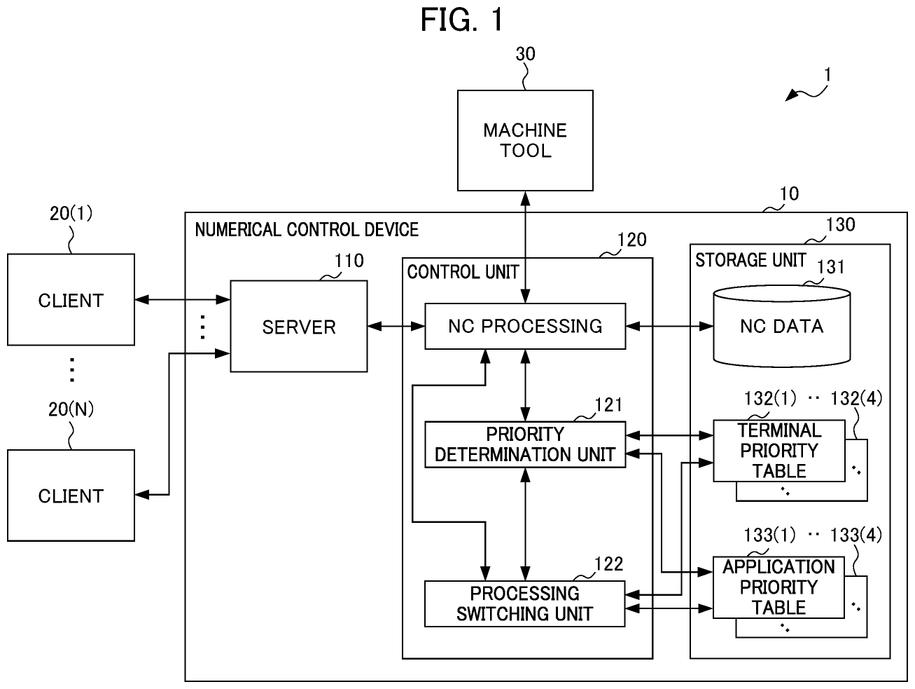

FIG. 1 is a functional block diagram showing a functional configuration example of a control system according to an embodiment. As shown in FIG. 1, the control system 1 includes a numerical control device 10, clients 20(1) to 20(N), and a machine tool 30 (N is an integer of 2 or more).

The numerical control device 10, the clients 20(1) to 20(N), and machine tool 30 may be directly connected to each other via a connection interface (riot shown). Furthermore, the numerical control device 10, the clients 20(1) to 20(N), and the machine tool 30 may be connected to each other via a network (not shown) such as a LAN (Local Area Network) or the Internet. In this case, the numerical control device 10, the clients 20(1) to 20(N), and the machine tool 30 include a communication unit (not shown) for communicating with each other by such a connection.

In the following, when there is no need to distinguish each of the clients 20(1) to 20(N) individually, they are collectively referred to as “client 20”.

The client 20 is, for example, a display device or a tablet. The client 20 has at least one application (hereinafter, may also be referred to “app”) such as “CNC operation app” that operates the numerical control device 10 to be described later, for example. The client 20 receives a command for executing an application from a user through an input device (not shown) such as a keyboard or a touch screen included in the client 20, and executes at least one application. The client 20 transmits, to the numerical control device 10 to be described later, a processing request requested by the application executed. Furthermore, the client 20 receives an output from the numerical control device 10, and displays the received output on an output device (not shown) such as a liquid crystal display included in the client 20.

“CNC operation application” that operates at least the machine tool 30 is installed in the client 20. Furthermore, “data logging application” that manages the operation status of the machine tool 30, “schedule management application” that manages the machining schedule, “memo application” that serves as a memo pad, etc. may be installed in the client 20.

The machine tool 30 is a machine tool known to those skilled in the art, and operates based on an operation command of the numerical control device 10 as a control device.

### Numerical Control Device 10

The numerical control device 10 is a numerical control device known to those skilled in the art, and generates an operation command based on a processing request from the client 20 or a machining program acquired from an external device (not shown) such as a CAD/CAM device, and transmits the generated operation command to the machine tool 30. Thus, the numerical control device 10 controls the operation of the machine tool 30. It should be noted that, when the machine tool 30 is a robot or the like, the numerical control device 10 may be a robot controller or the like.

As shown in FIG. 1, the numerical control device 10 includes a server 110, a control unit 120, and a storage unit 130. Furthermore, the control unit 120 includes a priority determination unit 121 and a processing switching unit 122.

### Server 110

The server 110 is, for example, a Web server and communicates with the client 20. When a processing request to the numerical control device 10 is received from the client 20, the server 110 outputs the processing request to the control unit 120 which will be described later. Furthermore, the server 110 receives, from the control unit 120, the response to the processing request from the client 20, and transmits the received response to the client 20.

### Storage Unit 130

The storage unit 130 is RAM (Random Access Memory), an HDD (Hard Disk Drive) or the like. The storage unit 130 stores an NC data 131, a terminal priority tables 132(1) to 132(4), and an application priority table 133(1) to 133(4).

For example, the NC data 131 stores a machining program generated by an external device (not shown) such as a CAD/CAM device, and setting values such as a tool offset amount and a workpiece coordinate.

The terminal priority tables 132(1) to 132(4) each store terminal priority information indicating priority of each of the clients 20 according to the number of requests of the processing requests that are set in advance within a predetermined period for each processing state for the industrial machine (hereinafter, also referred to as “processing state for the machine tool 30”), for example.

It should be noted that the processing state for the machine tool 30 includes, for example, “MEM mode (during machine operation)”, “MEM mode (during machine non-operation)”, “MDI mode (during machine operation)”, “MDI mode (during machine non-operation)”, “JOG mode (during machine operation)”, “HND mode (during machine operation)”, “JOG mode (during machine none-operation), “HND mode (during machine non-operation), “EDIT mode”, etc.

Here, the MEM mode is a memory mode, which is a mode of automatic operation based on the machining program. In addition, the MDI mode is a mode in which a machining program for operating the machine tool 30 is inputted one line by one to operate the machine tool 30. Furthermore, the EDIT mode is a mode for editing a processing program or a processing cycle. Furthermore, the JOG mode is a mode for moving a spindle or a table (not shown) of the machine tool 30 by a user continuing to press an axis movement button (not shown) for moving each axis of the machine tool 30 included in the numerical control device 10. The HND mode is a mode in which the user manually rotates a handle (not shown) included in the numerical control device 10 to move the spindle or the table (not shown) of the machine tool 30.

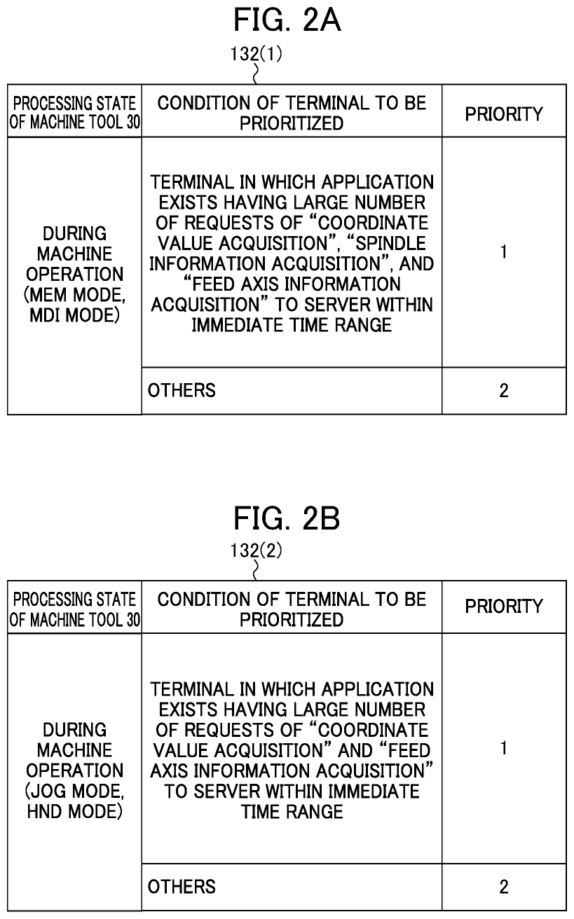

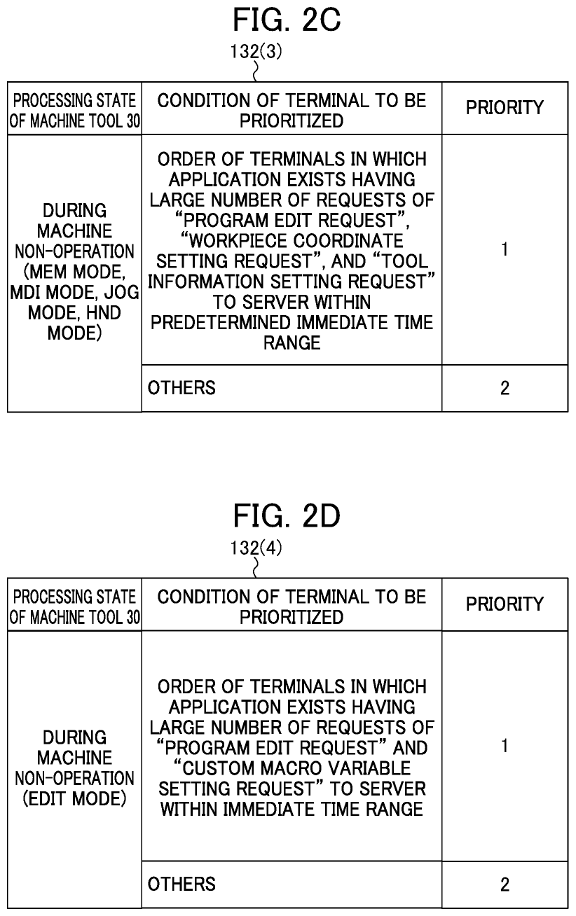

FIG. 2A is a diagram showing an example of the terminal priority table 132(1) when the processing state of the machine tool 30 is the MEM mode (during machine operation) or the MDI mode (during machine operation).

As shown in FIG. 2A, in the terminal priority table 132(1) in the MEM mode (during machine operation) or the MDI mode (during machine operation), the high priority “1” is set for a terminal (the client 20) in which an application exists having a large number of requests of “coordinate value acquisition”, “spindle information acquisition”, and “feed axis information acquisition” to the server 110 within an immediate time range as a predetermined period (for example, a period from the current time to the time one minute before). Since monitoring of collision using the coordinate value, monitoring of motor load or burning using the spindle information, and monitoring of the motor load or burning using the feed axis information are performed during machining, the client 20 performing the above information acquisition most frequently is prioritized.

On the other hand, in the terminal priority table 132(1), priority “2” may be set for terminals other than the client 20 having priority “1” as “others”.

FIG. 2B is a diagram showing an example of the terminal priority table 132(2) when the processing state of the machine tool 30 is the JOG mode (during machine operation) or the HND mode (during machine operation).

As shown in FIG. 2B, in the terminal priority table 132(2) in the JOG mode (during machine operation) or the HND mode (during machine operation), the high priority “1” is set for a terminal (the client 20) in which an application exists having the large number of requests of “coordinate value acquisition” and “feed axis information acquisition” to the server 110 within an immediate time range as a predetermined period (for example, a period from the current time to the time one minute before). Since monitoring of collision using the coordinate value and monitoring of the motor load or burning using the feed axis information are performed during machining, the client 20 performing the above information acquisition most frequently is preferably prioritized.

On the other hand, in the terminal priority table 132(2), priority “2” may be set for terminals other than the client 20 having priority “1” as “others”.

FIG. 2C is a diagram showing an example of the terminal priority table 132(3) when the processing state of the machine tool 30 is the MEM mode (during machine non-operation), the MDI mode (during machine non-operation), the JOG mode (during machine non-operation), or the HND mode (during machine non-operation).

As shown in FIG. 2C, in the terminal priority table 132(3) in the MEM mode (during machine non-operation), the MDI mode (during machine non-operation), the JOG mode (during machine non-operation), or the HND mode (during machine non-operation), the high priority “1” is set for a terminal (the client 20) in which an application exists having a large number of requests of “program edit request”, “workpiece coordinate setting request”, and “tool information setting request” to the server 110 within an immediate time range as a predetermined period (for example, a period from the current time to the time one minute before). Since setup, etc. for a subsequent machining is performed during machine non-operation (idle state), the client 20 performing the above setup in the numerical control device 10 frequently is preferably prioritized.

On the other hand, in the terminal priority table 132(3), priority “2” may be set for terminals other than the client 20 having priority “1” as “others”.

FIG. 2D is a diagram showing an example of the terminal priority table 132(4) when the processing state of the machine tool 30 is the EDIT mode (during machine non-operation).

As shown in FIG. 2D, in the terminal priority table 132(4) of the EDIT mode (during machine non-operation), the high priority “1” is set for a terminal (client 20) in which an application exists having a large number of requests of “program edit request” and “custom macro variable setting request” to the server 110 within an immediate time range as a predetermined period (for example, a period from the current time to the time one minute before). Since program editing is performed in the EDIT mode, the client 20 performing the program editing is preferably prioritized. It should be noted that, since there may be a case in which a custom macro variable is set while the program editing is performed in the EDIT mode, the terminal priority table 132(4) takes into account a setting request of the custom macro variable.

On the other hand, in the terminal priority table 132(4), priority “2” may be set for terminals other than the client 20 having priority “1” as “others”.

For example, the application priority tables 133(1) to 133(4) may store application priority information indicating the priority of applications according to the number of requests of processing requests to a terminal (client 20) for which the processing requests that is set in advance are performed within a predetermined period, or a predetermined application that is set in advance, for each of the processing states of the machine tool 30. For example, the highest priority (priority 1) may be set for “CMC operation application”, and priority “2” may be set for the other applications.

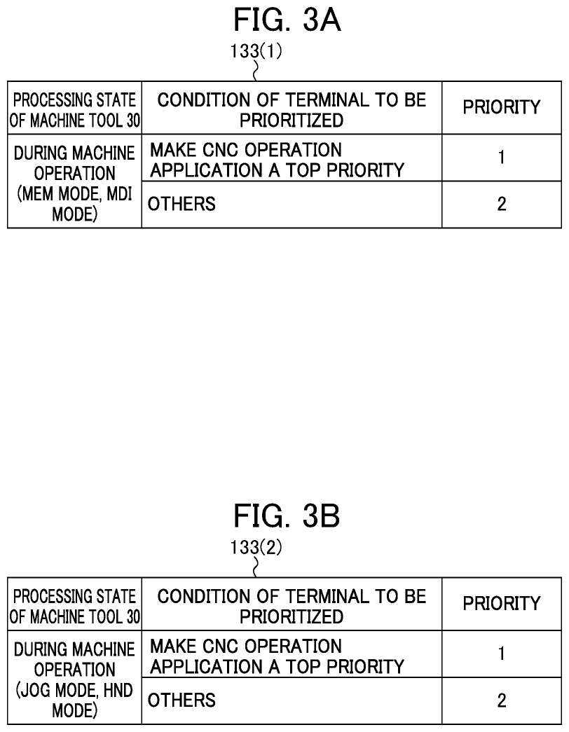

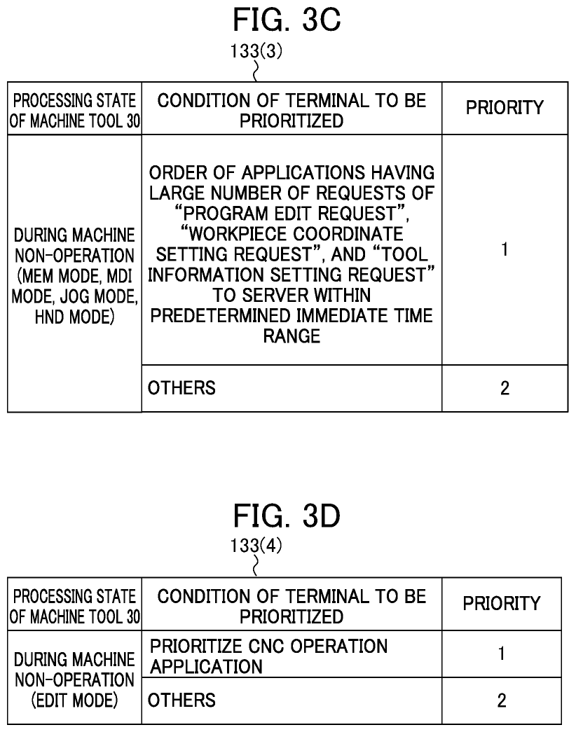

FIG. 3A is a diagram showing an example of the application priority table 133(1) when the processing state of the machine tool 30 is the MEM mode (during machine operation) or the MDI mode (during machine operation).

As shown in FIG. 3A, in the application priority table 133(1) of the MEM mode (during machine operation) or the MDI mode (during machine operation), the highest priority “1” is set for “CMC operation application” as a predetermined application. Since monitoring of collision using the coordinate value, monitoring of motor load or burning using the spindle information, and monitoring of the motor load or burning using the feed axis information are performed during machining, “CNC operation application” is prioritized.

On the other hand, in the application priority table 133(1), priority “2” may be set for applications other than the “CNC operation application” as “others”.

FIG. 3B is a diagram showing an example of the application priority table 133(2) when the processing state of the machine tool 30 is the JOG mode (during machine operation) or the HND mode (during machine operation).

As shown in FIG. 3B, in the application priority table 133(2) of the JOG mode (during machine operation) or the HMD mode (during machine operation), the highest priority “1” is set for “CMC operation application”. Since monitoring of collision using the coordinate value and monitoring of the motor load or burning using the feed axis information are required to be performed during machining, the highest priority “1” is set to “CMC operation application”.

On the other hand, in the application priority table 133(2), priority “2” may be set for applications other than “CMC operation application” as “others”.

FIG. 3C is a diagram showing an example of the application priority table 133(3) when the processing state of the machine tool 30 is the MEM mode (during machine non-operation), the MDI mode (during machine non-operation), the JOG mode (during machine non-operation), or the HND mode (during machine non-operation).

As shown in FIG. 3C, in the application priority table 133(3) of the MEM mode (during machine non-operation), the MDI mode (during machine non-operation), the JOG mode (during machine non-operation), or the HND mode (during machine non-operation), the highest priority “1” is set for an application having a large number of requests of “program edit request”, “workpiece coordinate setting request”, and “tool information setting request” to the server 110 within an immediate time range as a predetermined period (for example, a period from the current time to the time one minute before). Since setup, etc. for a subsequent machining is required to be performed during machine non-operation (idle state), the highest priority “1” is set for an application that performs the setting to the numerical control device 10 frequently.

On the other hand, in the application priority table 133(3), priority “2” may be set for applications other than the application having priority “1” as “others”.

FIG. 3D is a diagram showing an example of the application priority table 133(4) when the processing state of the machine tool 30 is the EDIT mode (during machine non-operation).

As shown in FIG. 3D, in the application priority table 133(4) of the EDIT mode (during machine non-operation), the highest priority “1” is set for “CNC operation application”. Since it is necessary to perform the program editing with “CNC operation application” in the EDIT mode, the highest priority “1” is set for “CNC operation application”.

On the other hand, in the application priority table 133(4), priority “2” may be set for applications other than “CNC operation application” as “others”.

As described above, the terminal priority tables 132(1) to 132(4) and the application priority tables 133(1) to 133(4) are exemplified according to the processing state of the machine tool 30. However, these are merely examples, and the present invention is not limited thereto. The user may set the terminal priority tables 132(1) to 132(4) and the application priority tables 133(1) to 133(4) as appropriate.

In the following, when there is no need to distinguish each of the terminal priority tables 132(1) to 132(4) individually, they are collectively referred to as “terminal priority table 132”. Furthermore, when there is no need to distinguish each of the application priority tables 133(1) to 133(4) individually, they are collectively referred to as “application priority table 133”.

### Control Unit 120

The control unit 120 includes a CPU (Central Processing Unit), ROM (Read Only Memory), RAM, CMOS (Complementary Metal-Oxide Semiconductor) memory, and the like, which are known to those skilled the art, configured to communicate with each other via a bus.

The CPU is a processor that generally controls the numerical control device 10. The CPU reads the system program and the application program stored in the ROM through the bus, and controls the entire numerical control device 10 in accordance with the system program and the application program. Thus, as shown in FIG. 1, the control unit 120 is configured to realize the function of the priority determination unit 121 and the processing switching unit 122. Various data such as temporary calculation data and display data are stored in the RAM. Furthermore, the CMOS memory is backed up by a battery (not shown), and is configured as nonvolatile memory in which the stored state is retained even when the power of the numerical control device 10 is turned off.

Furthermore, the control unit 120 executes NC processing for the processing request received from the client 20, and outputs an operation command to the machine tool 30.

More specifically, in a case in which there is a plurality of unprocessed processing requests received from the client 20, the control unit 120 causes the priority determination unit 121 to be described later to determine the priority of clients 20 and the priority of applications based on the terminal priority table 132 and the application priority table 133 according to the processing state of the machine tool 30. The control unit 120 causes the processing switching unit 122 to be described later to switch the order of the plurality of processing requests based on the priority of clients 20 and the priority of applications determined by the priority determination unit 121. Thereafter, the control unit 120 executes the NC processing for each of the plurality of processing requests in the switched order.

Furthermore, the control unit 120 may read the machining program of the NC data 131, execute the NC processing based on the machining program thus read, and output an operation command to the machine tool 30.

The priority determination unit 121 determines the priority of clients 20 and the priority of applications based on the terminal priority table 132 and the application priority table 133 according to the processing state of the machine tool 30.

In the following, the determination processing of the priority of clients 20 and the priority of applications for each of the processing states of the machine tool 30 will be explained in each of the following cases: (A) a case in which there are a plurality of clients 20, and each client 20 executes one application; (B) a case in which one client 20 executes a plurality of applications; and (C) there are a plurality of clients 20, and each client 20 executes a plurality of applications.

### (A) Regarding a Case in Which There are a Plurality of Clients 20 and Each Client 20 Executes One Application

First of all, a description will be given of the determination processing of the priority of clients 20 and the priority of applications for each of the processing states of the machine tool 30 by the priority determination unit 121 in a case in which there are a plurality of clients 20, and each client 20 executes one application.

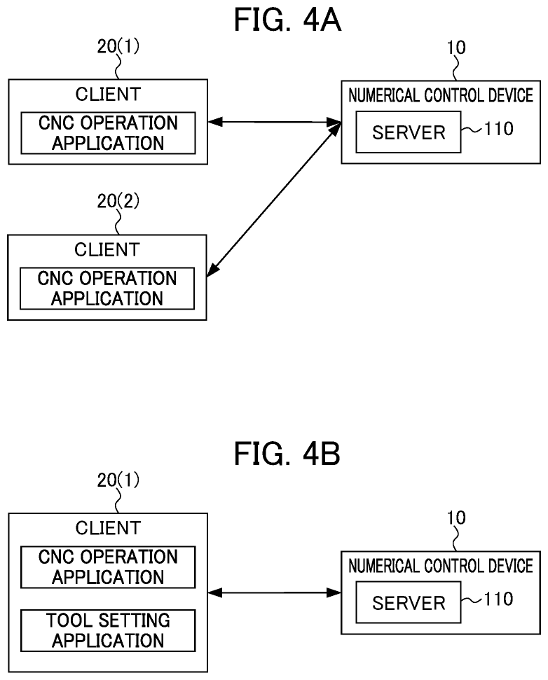

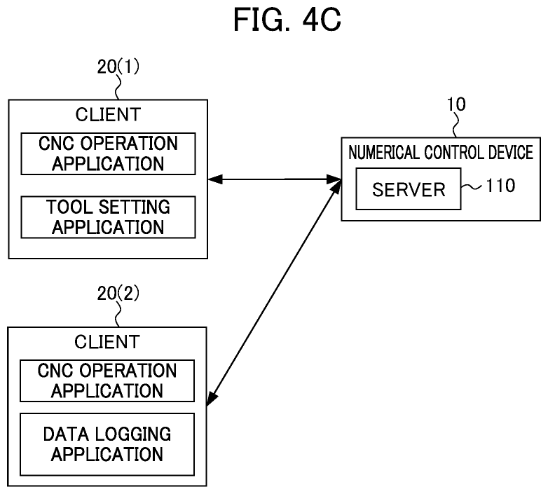

FIG. 4A is a diagram showing an example in which two clients 20 execute one application, and communicate with the server 110 of the numerical control device 10 to process the processing requests. In FIG. 4A, the client 20(1) and the client 20(2) executes “CNC operation application” for operating the numerical control device 10. It should be noted that there may be a plurality of clients 20, for example, three or more clients 20, that communicate with the server 110 of the numerical control device 10 to process the processing requests, and such a case is similar to the case of the two clients 20 of FIG. 4A.

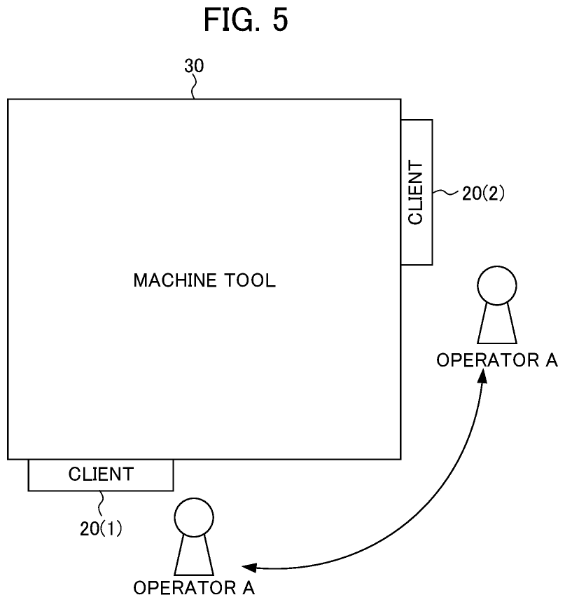

In addition, as shown in FIG. 5, the status of FIG. 4A corresponds to, for example, a case in which the machine tool 30 is large, and the two clients 20(1) and 20(2) as indicators are arranged in the machine tool 30. In this case, since the appearance of the workpiece differs depending on the direction, operator A may operate the client 20(1) or the client 20(2) by changing the position as appropriate.

Hereinafter, in the status of FIG. 4A, a description will be given of determination processing of the priority of clients 20 and the priority of applications for each of the processing states of the machine tool 30 by the priority determination unit 121 will be described.

It should be noted that, in a case of the status of FIG. 4A, since the clients 20(1) and 20(2) execute only one application, which is “CNC operation application”, the priority determination unit 121 omits the determination processing of the priority of applications based on the application priority table 133.

### Case in Which the Processing State of the Machine Tool 30 is the MEM Mode (During Machine Operation) or the MDI Mode (During Machine Operation)

It is assumed that, when the processing state of the machine tool 30 is in the MEM mode (during machine operation) or the MDI mode (during machine operation), in the status of FIG. 4A, the “CNC operation application” of the client 20(1), for example, makes the request for the coordinate value acquisition 120 times, the request for spindle information acquisition 60 times, and the request for the feed axis information acquisition, respectively, for example, within an immediate time range from the current time 10:01 to the time one minute before. Meanwhile, it is also assumed that the “CNC operation application” of the client 20(2) makes the request for the coordinate value acquisition 0 times, the request for the spindle information acquisition 60 times, and the request for the feed axis information acquisition 60 times, respectively, for example, within an immediate time range from the same current time of 10:01 to the time one minute before. In this case, the total number of requests for the coordinate value acquisition, the spindle information acquisition, and the feed axis information acquisition of the “CNC operation application” of the client 20(1) is 240 times, and the total number of requests for the coordinate value acquisition, the spindle information acquisition, and the feed axis information acquisition of the “CMC operation application” of the client 20(2) is 120 times.

As described above, during machining execution, since it is necessary to perform monitoring of collision using the coordinate values, monitoring of motor load or burning using the spindle information, and/or monitoring of motor load or burning using the feed axis information, the priority determination unit 121 determines the client 20(1) that performs the above information acquisition most frequently as priority “1” based on the terminal priority table 132(1) of FIG. 2A. On the other hand, the priority determination unit 121 determines the client 20(2) as priority “2” based on the terminal priority table 132(1) of the FIG. 2A.

### Case in which the Processing Status of the Machine Tool 30 is the JOG Mode (During Machine Operation) or the HND Mode (During Machine Operation)

It is assumed that, when the processing state of the machine tool 30 is in the JOG mode (during machine operation) or the HND mode (during machine operation), in the state of FIG. 4A, the “CNC operation application” of the client 20(1), for example, makes the request for the coordinate value acquisition 120 times and the request for the feed axis information acquisition 60 times, for example, within an immediate time range from the current time 10:01 to the time one minute before. Meanwhile, it is also assumed that the “CNC. operation application” of the client 20(2) makes the request for the coordinate value acquisition 0 times and the request for the feed axis information acquisition 60 times, for example, within the same immediate time. In this case, the total number of requests for the coordinate value acquisition and the feed axis information acquisition of the “CNC operation application” of the client 20(1) is 180 times, and the total number of requests for the coordinate value acquisition and the feed axis information acquisition of the “CNC operation application” of the client 20(2) is 60 times.

As described above, during the machining execution, since monitoring of collision using the coordinate values and/or monitoring of motor load or burning using the feed axis information is performed using the coordinate value, the priority determination unit 121 determines the client 20(1) that performs the above information acquisition most frequently as priority “1” based on the terminal priority table 132(2) of FIG. 2B. On the other hand, the priority determination unit 121 determines the client 20(2) as priority “2” based on the terminal priority table 132(2) of FIG. 2B.

### Case in Which the Processing State of the Machine Tool 30 is in the MEM Mode (Machine Non-Operation), the MDI Mode (Machine Non-Operation), the JOG Mode (Machine Non-Operation), or the HND Mode (Machine Non-Operation)

It is assumed that, when the machine tool 30 is the MEM mode (machine non-operation), the MDI mode (machine non-operation), the JOG mode (machine non-operation), or the HND mode (machine non-operation), in the state of FIG. 4A, the “CNC operation application” of the client 20(1), for example, makes the program edit request 3 times, the workpiece coordinate setting request 2 times, and the tool information setting request 1 time, for example, within an immediate time range from the, current time 10:01 to the time one minute before. In addition, it is also assumed that “tool setting application” of the client 20(1) makes the tool information setting request 1 time within the same current time range. On the other hand, it is assumed that “CNC operation application” of the client 20(2) makes the program edit request 2 times, the workpiece coordinate setting request 0 times, and the tool information setting request 0 times, respectively, within the same immediate time range. In this case, the total number of requests of the program edit request, the workpiece coordinate setting request, and the tool information setting request of “CNC operation application” and “tool setting application” of the client 20(1) is 7 times, and the total number of requests of the program edit request, the workpiece coordinate setting request, and the tool information setting request of “CNC operation application” of the client 20(2) is 2 times.

As described above, since setup for subsequent machining or the like is performed during the machine non-operation, the priority determination unit 121 determines the client 20(1) that performs the setting to the numerical control device 10 frequently as priority “1” based on the terminal priority table 132(3) of FIG. 2C. On the other hand, the priority determination unit 121 determines the client 20(2) as priority “2” based on the terminal priority table 132(3) of FIG. 2C.

### Case in Which the Processing State of the Machine Tool 30 is in the EDIT Mode (Machine Non-Operation)

It is assumed that, when the processing state of the machine tool 30 is the EDIT mode (machine non-operation), for example, in the state of FIG. 4A, “CNC operation application” of the client 20(1) makes the program edit request 3 times and the custom macro variable setting request 1 time within an immediate time range from the current time of 10:01 to the time one minute before. On the other hand, it is also assumed that the “CNC operation application” of the client 20(2) makes the program edit request 2 times and the custom macro variable setting request 0 times, respectively, within the same immediate time range. In this case, the total number of the program edit requests and the custom macro variable setting requests of “CNC operation application” of the client 20(1) is 4 times, and the total number of the program edit requests and the custom macro variable setting requests of “CNC operation application” of the client 20(2) is 2 times.

As described above, since EDIT mode may set the custom macro variable while performing program editing, the priority determination unit 121 determines the client 20(1) as priority “1” based on the terminal priority table 132(4) in FIG. 2D. On the other hand, the priority determination unit 121 determines the client 20(2) as priority “2” based on the terminal priority table 132(4) in FIG. 2D.

### (B) Regarding Case in Which One Client 20 Executes a Plurality of Applications

Next, a description will be given of the determination processing of the priority of clients 20 and the priority of applications for each of the processing states of the machine tool 30 by the priority determination unit 121 in a case in which one client 20 executes a plurality of applications.

FIG. 4B is a diagram showing an example in which one client 20 executes two applications and communicates with the server 110 of the numerical control device 10 to process the processing requests. In FIG. 4B, the client 20(1) executes “CNC operation application” and the “tool setting application”. It should be noted that the client 20 that communicates with the server 110 of the numerical control device 10 may be clients 20(2)-20(N), and is similar to the case of the client 20(1) in FIG. 4B.

In addition, although the client 20(1) executes two of the “CNC operation application” and the “tool setting application”, it may execute three or more applications. It should be noted that, in this case, the plurality of applications to be executed includes “CNC operation application” for operating the numerical control device 10.

Hereinafter, in the status of FIG. 4B, the determination processing of the priority of clients 20 and the priority of applications for each of the processing states of the machine tool 30 by the priority determination unit 121 will be described.

In the status shown in FIG. 4B, since only the client 20(1) is the terminal to communicate with the server 110 of the numerical control device 10, the priority determination unit 121 omits the determination processing of the priority of clients based on the terminal priority table 132.

### Case in Which the Processing State of the Machine Tool 30 is in the MEM Mode (During Machine Operation) or the MDI Mode (During Machine Operation)

It is assumed that, when the processing state of the machine tool 30 is the MEM mode (during machine operation) or the MDI mode (during machine operation), in the state of FIG. 4B, the priority determination unit 121 determines “CNC operation application” of the client 20(1) as priority “1″ and determines “tool setting application”as priority ”2″based on the application priority table 133(1) of FIG. 3A.

### Case in Which the Processing State of the Machine Tool 30 is in the JOG Mode (During Machine Operation) or the HND Mode (During Machine Operation)

It is assumed that, when the processing state of the machine tool 30 is the JOG mode (during machine operation) or the HND mode (during machine operation), in the state of FIG. 4B, the priority determination unit 121 determines “CNC operation application” of the client 20(1) as priority “1” and determines “tool setting application” as priority “2” based on the application priority table 133(2) of FIG. 3B.

### Case in Which the Processing State of the Machine Tool 30 is in the MEM Mode (During Machine Non-Operation), the MDI Mode (During Machine Non-Operation), the JOG Mode (During Machine Non-Operation), or the HND Mode (During Machine Non-Operation)

It is assumed that, when the machine tool 30 is the MEM mode (during machine non-operation), the MDI mode (during machine non-operation), the JOG mode (during machine non-operation), or the HND mode (during machine non-operation), in the status of FIG. 4B, the “CNC operation application” of the client 20(1) makes, for example, the program edit request 3 times, the workpiece coordinate setting request 2 times, and the tool information setting request 1 time, for example, within an immediate time range from the current time 10:01 to 1 minute. On the other hand, it is also assumed that the “tool setting application” of the client 20(1) makes the tool information setting request 2 times within the same immediate time range. In this case, the total number of the program edit requests, the workpiece coordinate setting requests, and the tool information setting requests of “CNC operation application” of the client 20(1) is 6 times, and the total number of the program edit requests, the workpiece coordinate setting requests, and the tool information setting requests of “tool setting application” of the client 20(1) is 2 times.

As described above, since it is necessary to perform the setup for subsequent machining during the machine non-operation, the priority determination unit 121 determines the “CNC operation application” that performs the setting to the numerical control device 10 frequently as priority “1” based on the application priority table 133(3) of FIG. 3C. On the other hand, the priority determination unit 121 determines “the tool setting application” as priority “2” based on the application priority table 133(3) of FIG. 3C. <Case in which the processing state of the machine tool 30 is in the EDIT mode (during machine non-operation)>

When the processing state of The machine tool 30 is the EDIT mode (during machine non-operation), in the status of FIG. 4B, the priority determination unit 121 determines “CNC operation application” of the client 20(1) as priority “1” and determines “tool setting application” as priority “2” based on the application priority table 133(4) of FIG. 3D.

### (C) Regarding Case in Which There is a Plurality of Clients 20 and Each Client 20 Executes a Plurality of Applications

Next, a description will be given of the determination processing of the priority of clients 20 and the priority of applications for each of the processing states of the machine tool 30 by the priority determination unit 121 in a case in which there is a plurality of clients 20 and each client 20 executes a plurality of applications.

FIG. 4C is a diagram showing an example in which two clients 20 execute two applications, and communicate with the servers 110 of the numerical control device 10 to process the processing requests. In FIG. 4C, the client 20(1) executes “CNC operation application” and “tool setting application”, and the client 20(2) executes “CNC operation application” and “data logging application”. It should be noted that the client 20 that communicates with the server 110 of the numerical control device 10 to process the processing requests may be a plurality of clients 20 such as three or more clients, and each client 20 may execute three or more applications. It should be noted that, in this case, the plurality of applications to be executed includes “CNC operation application” for operating the numerical control device 10.

Hereinafter, a description be given of the determination processing of the priority of clients 20 and the priority of applications for each of the processing states of the machine tool 30 by the priority determination unit 121 in the status of FIG. 4C.

### Case in Which the Processing State of the Machine Tool 30 is in the MEM Mode (During Machine Operation) or the MDI Mode (During Machine Operation)

It is assumed that, when the processing state of the machine tool 30 is the MEM mode (during machine operation) or the MDI mode (during machine operation), in the status of FIG. 4C, “CNC operation application” of the client 20(1), for example, makes the coordinate value request 120 times, the spindle information acquisition 60 times, and the feed axis information acquisition 60 times, respectively, for example, within an immediate time range from the current time 10:01 to the time one minute before. Meanwhile, it is also assumed that “CNC operation application” of the client 20(2) makes the coordinate value acquisition request 0 times, the spindle information acquisition request 60 times, and the feed axis information acquisition request 60 times, respectively, for example, within the immediate time range from the same current time of 10:01 to the time one minute before. In this case, the total number of the coordinate value acquisition requests, the spindle information acquisition requests, and the feed axis information acquisition requests of “CNC operation application” of the client 20(1) is 240 times, and the total number of the coordinate value acquisition requests, the spindle information acquisition requests, and the feed axis information acquisition requests of“CNC operation application” of the client 20(2) is 120 times.

As described above, it is necessary to perform monitoring of collision using the coordinate values, monitoring of motor load or burning using the spindle information, and/or monitoring of motor load or burning using the feed axis information during machining execution, the priority determination unit 121 determines the client 20(1) that performs the above information acquisition most frequently as priority “1” based on the terminal priority table 132(1) of FIG. 2A. On the other hand, the priority determination unit 121 determines the client 20(2) as priority “2” based on the terminal priority table 132(1) of FIG. 2A.

Next, the priority determination unit 121 determines the priority of applications to be executed in each of the clients 20(1) and 20(2) based on the application priority table 133(1) of FIG. 3A.

More specifically, based on the application priority table 133(1) of FIG. 3A, the priority determination unit 121 determines “CNC operation application” of the client 20(1) determined to have priority of “1” as priority “1”, and determines “tool setting application” as priority “2”. Furthermore, the priority determination unit 121 determines “CNC operation application” of the client 20(2) determined to have priority “2” as priority “1”, and determines “data logging application” as priority “2” based on the application priority table 133(1) of FIG. 3A.

### Case in Which the Processing State of the Machine Tool 30 is in the JOG Mode (During Machine Operation) or the HND Mode (During Machine Operation)

It is assumed that, when the processing state of the machine tool 30 is in the JOG mode (during machine operation) or the HND mode (during machine operation), in the status of FIG. 4C, “CNC operation application” of the client 20(1), for example, makes the coordinate value acquisition request 120 times and the feed axis information acquisition request 60 times, for example, within an immediate time range from the current time of 10:01 to the time one minute before. Meanwhile, it is also assumed that “CNC operation application” of the client 20(2) makes the coordinate value acquisition request 0 times and the feed axis information acquisition request 60 times, for example, within the same immediate time range. In this case, the total number of the coordinate value acquisition requests and the feed axis information acquisition requests of “CNC operation application” of the client 20(1) is 180 times, and the total number of the coordinate value acquisition requests and the feed axis information acquisition requests of “CNC operation application” of the client 20(2) is 60 times.

As described above, since it is necessary to perform monitoring of collision using the coordinate values and/or monitoring of motor load or burning using the feed axis information during machining execution, the priority determination unit 121 determines the client 20(1) that performs the above information acquisition most frequently as priority “1” based on the terminal priority table 132(2) of FIG. 2B. On the other hand, the priority determination unit 121 determines the client 20(2) as priority “2” based on the terminal priority table 132(2) of FIG. 2B.

Next, the priority determination unit 121 determines the priority of applications to be executed in each of the clients 20(1) and 20(2) based on the application priority table 133(2) in FIG. 3B.

More specifically, based on the application priority table 133(2) of FIG. 3B, the priority determination unit 121 determines “CNC operation application” of the client 20(1) determined to have priority “1” as priority “1”, and determines “tool setting application” as priority “2”. Furthermore, based on the application priority table 133(2) of FIG. 3B, the priority determination unit 121 determines “CNC operation application” of the client 20(2) determined to have priority “2” as priority “1”, and determines “data logging application” as priority “2”.

### Case in Which the Processing State of the Machine Tool 30 is in the MEM Mode (During Machine Non-Operation), the MDI Mode (During Machine Non-Operation), the JOG Mode (During Machine Non-Operation), or the HND Mode (During Machine Non-Operation)

It is assumed that, when the processing state of the machine tool 30 is the MEM mode (during machine non-operation), the MDI mode (during machine non-operation), the JOG mode (during machine non-operation), or the HND mode (during machine non-operation), in the status of FIG. 4C, “CNC operation application” of the client 20(1) makes, for example, the program edit request 3 times, the workpiece coordinate setting request 2 times, and the tool information setting request 1 time, for example, within an immediate time range from the current time 10:01 to 1 minute before. In addition, it is also assumed that “tool setting application” of the client 20(1) makes the tool information setting request 1 time within the same immediate time range. On the other hand, it is also assumed that “CNC operation application” of the client 20(2) makes the program edit request 2 times, the workpiece coordinate setting request 0 times, and the tool information setting request 0 times, respectively, within the same immediate time range. In this case, the total number of the program edit requests, the workpiece coordinate setting requests, and the tool information setting requests of “CNC operation application” and “tool setting application” of the client 20(1) is 7 times, and the total number of the program edit requests, the workpiece coordinate setting requests, and the tool information setting requests of “CNC operation application” of the client 20(2) is 2 times.

As described above, since it is necessary to perform the setup for subsequent machining or the like during machine non-operation, the priority determination unit 121 determines the client 20(1) that performs the setting to the numerical control device 10 frequently as priority “1” based on the terminal priority table 132(3) of FIG. 2C. On the other hand, the priority determination unit 121 determines the client 20(2) as priority “2” based on the terminal priority table 132(3) of FIG. 2C.

Next, the priority determination unit 121 determines the priority of applications to be executed in each of the clients 20(1) and 20(2) based on the application priority table 133(3) of FIG. 3C.

More specifically, as described above, “CNC operation application” of the client 20(1) determined to have priority “1” makes the program edit request, the workpiece coordinate setting request, and the tool information setting request 6 times within the immediate time range, and “tool setting application” makes the tool information setting request 1 time within the immediate time range. Therefore, the priority determination unit 121 determines “CNC operation application” of the client 20(1) determined to have priority “1” as priority “1” and determines “tool setting application” as priority “2” based on the application priority table 133(3) of FIG. 3C.

On the other hand, “CNC operation application” of the client 20(2) determined to have priority “2” makes the program edit request, the workpiece coordinate setting request, and the tool information setting request 2 times in total within the immediate time range. Therefore, the priority determination unit 121 determines “CNC operation application” of the client 20(2) determined to have priority “2” as priority “1” based on the application priority table 133(3) of FIG. 3C, and determines “data logging application” as priority “2”.

### Case in Which the Processing State of the Machine Tool 30 is in the EDIT (During Machine Non-Operation)

It is assumed that, when the processing state of the machine tool 30 is the EDIT mode (during machine non-operation), for example, in the status of FIG. 4C, “CNC operation application” of the client 20(1) makes the program edit request 3 times and the custom macro variable setting request 1 time within the immediate time range from the current time of 10:01 to the time one minute before. On the other hand, it is also assumed that “CNC operation application” of the client 20(2) makes the program edit request 2 times and the custom macro variable setting request 0 times, respectively, within the same immediate time range. In this case, the total number of the program edit requests and the custom macro variable setting requests of “CNC operation application” of the client 20(1) is 4 times, and the total number of the program edit requests and the custom macro variable setting requests of “CNC operation application” of the client 20(2) is 2 times.

As described above, since the EDIT mode may set the custom macro variable while performing the program editing, the priority determination unit 121 determines the client 20(1) as priority “1” based on the terminal priority table 132(4) of FIG. 2D. On the other hand, the priority determination unit 121 determines The client 20(2) as priority “2” based on the terminal priority table 132(4) of FIG. 2D.

Next, the priority determination unit 121 determines the priority of applications to be executed in each of the clients 20(1) and 20(2) based on the application priority table 133(4) in FIG. 3D.

More specifically, based on the application priority table 133(4) of FIG. 3D, the priority determination unit 121 determines “CNC operation application” of the client 20(1) determined to have priority “1” as priority “1” and determines “tool setting application” as priority “2”. Furthermore, the priority determination unit 121 determines “CNC operation application” of the client 20(2) determined to have priority “2” as priority “1” based on the application priority table 133(4) of FIG. 3D, and determines “data logging application” as priority “2”.

The processing switching unit 122 switches the order of the NC processing for each of the plurality of unprocessed processing requests received from the client 20 based on the priority of clients 20 and the priority of applications determined by the priority determining unit 121.

More specifically, the processing switching unit 122 switches the processing order so as to process in order from the NC processing of the unprocessed processing request received from the clients 20 determined to have the highest priority “1” or the unprocessed processing request of the applications determined to have priority “1” among the clients 20 determined to have priority “1” based on, for example, the priority of clients 20 and the priority of applications determined by the priority determining unit 121.

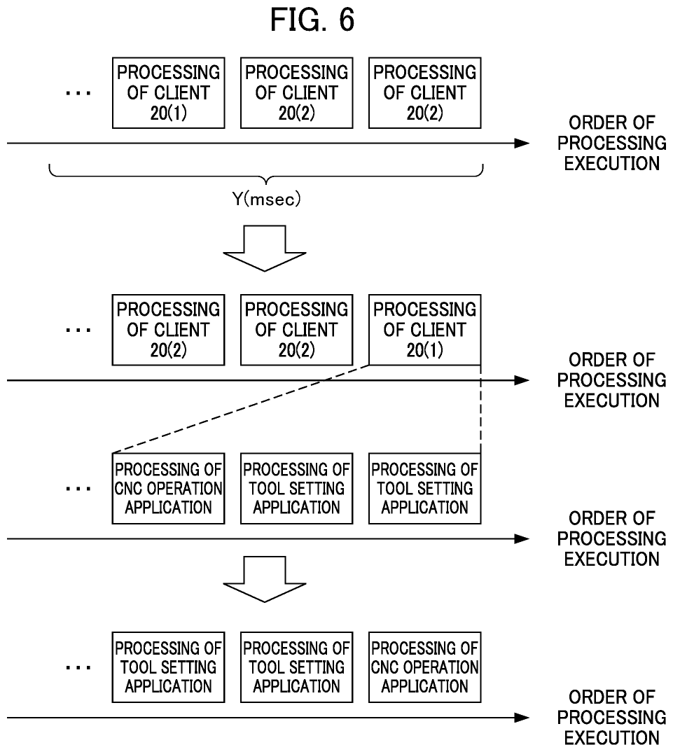

FIG. 6 is a diagram showing an example of switching the order of the NC processing of a plurality of processing requests based on the priority of clients 20 and the priority of applications in the case of FIG. 4C. In other words, FIG. 6 refers to a case in which there are two clients 20, and each client 20 executes two or more applications, as shown in FIG. 4C.

The first stage of FIG. 6 shows a plurality of unprocessed processing requests in the order received from the client 20(1) and the client 20(2). The second stage of FIG. 6 shows the order of unprocessed processing requests switched in the order of the client 20 having the higher priority based on the priority of clients 20 determined by the priority determination unit 121. The third row of FIG. 6 shows a processing request from the client 20(1) among the processing requests of the client 20 in the second stage of FIG. 6. The fourth row of FIG. 6 shows the order of the unprocessed processing requests that are switched in the order of application having higher priority among the unprocessed processing requests of the client 20(1) based on the priority of applications determined by the priority determination unit 121.

With such a configuration, the numerical control device 10 is able to reliably execute processing of the client 20 or the application to be prioritized according to the processing contents for each processing state for the industrial machine 30, and thus it is possible to suppress the delay of processing to be immediately performed.

It should be noted that the plurality of processing requests may be received from the client 20 at a time, or may be sequentially received from the client 20 and stored in memory (not shown) such as RAM included in the numerical control device 10.

Furthermore, although FIG. 6 shows the case of FIG. 4C, the same applies to the cases of FIGS. 4A and 4B.

### Control Processing of Numerical Control Device 10

Next, a description will be given for operation according to the control processing of the numerical control device 10 according to the present embodiment.

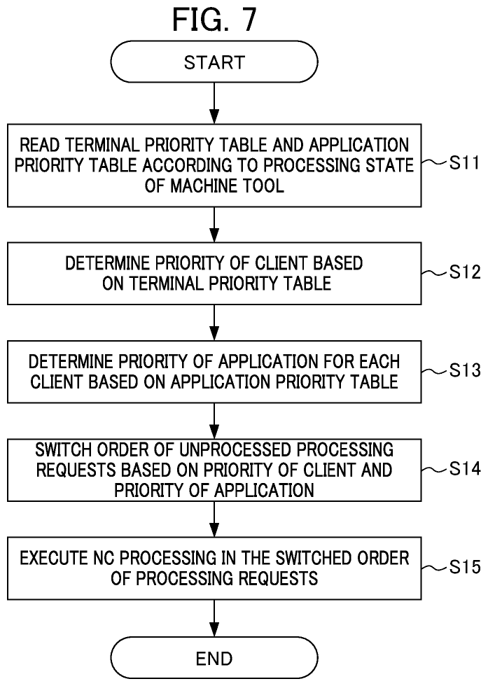

FIG. 7 is a flowchart for explaining the control processing of the numerical control device 10.

In Step S11, the priority determination unit 121 reads the terminal priority table 132 and the application priority table 133 in accordance with the processing state of the machine tool 30.

In Step S12, the priority determination unit 121 determines the priority of clients 20 based on the terminal priority table 132 read in Step S11.

In Step S13, the priority determination unit 121 determines the priority of applications for each client 20 of which the priority has been determined in Step S12 based on the application priority table 133 read in Step S11.

In Step S14, the processing switching unit 122 switches the order of the NC processing for each of the plurality of unprocessed processing requests in the order of higher priority based on the priority of clients 20 and the priority of applications determined in Step S12 and Step S13.

In Step S15, the control unit 120 executes the NC Processing in the order of higher processing request priority switched Step S14.

With such a configuration, in a case in which there is a plurality of unprocessed processing requests received from the client 20, the numerical control device 10 according to an embodiment determines the priority of clients 20 and the priority of applications based on the terminal priority table 132 and the application priority table 133 according to the processing state of the machine tool 30. The numerical control device 10 switches the NC processing for each of the plurality of unprocessed processing requests in the order of higher priority based on the priority of clients 20 and the priority of applications thus determined.

With such a configuration, the numerical control device 10 is able to reliably execute processing of the client 20 or the application to be prioritized according to the processing contents for each processing state for the industrial machine 30, and thus it is possible to suppress the delay of processing to be immediately performed.

Although one embodiment has been described above, the numerical control device 10 is not limited to the above-described embodiment, and includes modifications, improvements, and the like within a scope that can achieve the purpose.

### Modification Example 1

In the above-described embodiment, the numerical control device 10 switches the order of the NC processing for the plurality of unprocessed processing requests received from the client 20 based on the priority of clients 20 and the priority of applications determined by using the terminal priority table 132 and the application priority table 133 according to the processing state of the machine tool 30. However, the present invention is not limited thereto. For example, the numerical control device 10 may monitor the processing load of the numerical control device 10, the communication load with the client 20, and the processing load of the server 110. Furthermore, in a case in which any of the loads is higher than a predetermined value, the numerical control device 10 may determine the priority of clients 20 and the priority of applications based on the terminal priority table 132 and the application priority table 133, and switch the order of the NC processing for the plurality of unprocessed processing requests received from each of the clients 20.

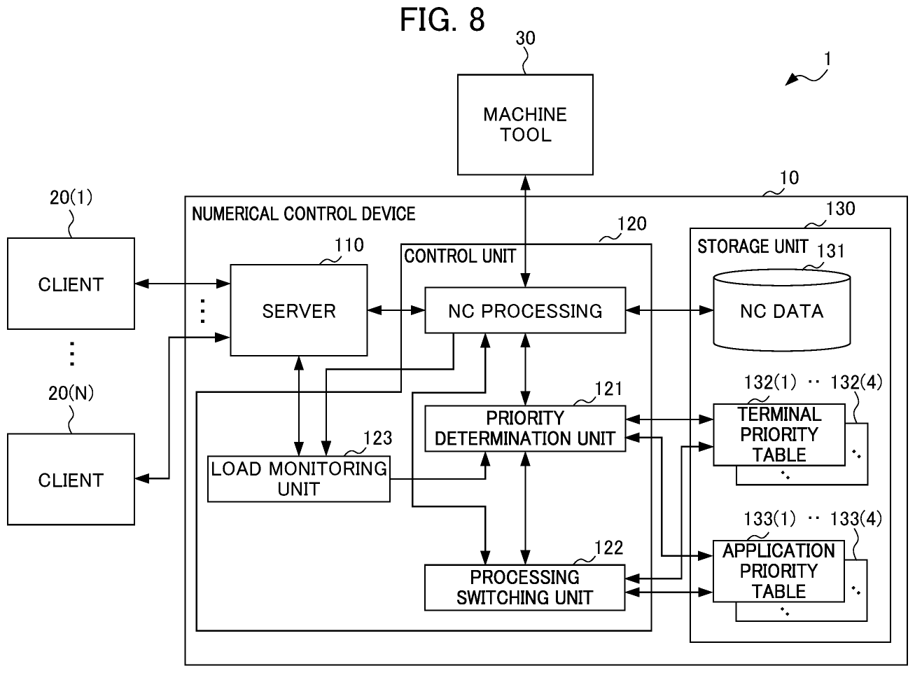

FIG. 8 is a functional block diagram showing a functional configuration example of a control system.

As shown in FIG. 8, the control unit 120 of the numerical control device 10 has the function of a load monitoring unit 123 that monitors the processing load of the numerical control device 10, the communication load with the client 20, and the processing load of the server 110. Furthermore, the load monitoring unit 123 outputs a monitoring result to the priority determination unit 121. Based on the monitoring result from the load monitoring unit 123, in a case in which any load among the processing load of the numerical control device 10, the communication load between the client 20 and the server 110, and the processing load of the server 110 is higher than a predetermined value, the priority determination unit 121 reads the terminal priority table 132 and the application priority table 133 according to the processing state of the machine tool 30. The priority determination unit 121 determines the priority of clients 20 and the priority of applications based on the terminal priority table 132 and the application priority table 133 according to the processing state of the machine tool 30. The processing switching unit 122 switches the order of the NC processing of each of the plurality of unprocessed processing requests received from the client 20 based on the priority of clients 20 and the priority of applications thus determined.

With such a configuration, even when any of the processing load of the numerical control device 10, the communication load between the client 20 and the server 110, and the processing load of the server 110 becomes high, the numerical control device 10 is able to reliably execute processing of the client 20 or the application to be prioritized according to the processing contents for each processing state for the industrial machine 30, and thus it is possible to suppress the delay of processing to be immediately performed.

It should be noted that the predetermined value may be appropriately set according to the processing capability of the numerical control device 10, the reception frequency of the processing request from the client 20, etc.

### Modification Example 2

For example, in the above-described embodiment, the numerical control device 10 determines the priority of clients 20 and the priority of applications based on the terminal priority table 132 and the application priority table 133 according to the processing state of the machine tool 30. However, the present invention is not limited thereto. For example, in a case in which the processing state for the machine tool 30 has changed after the switching, the numerical control device 10 may determine the priority of clients 20 and the priority of applications again based on the determination of the priority of clients 20 and the priority of applications after the change. Thereafter, the numerical control device 10 may again switch the order of the NC processing for each of the plurality of unprocessed processing requests from the client 20 based on the priority of clients 20 and the priority of applications thus determined again.

### Modification Example 3

In the embodiments and modification examples described above, the numerical control device 10 has the terminal priority tables 132(1) to 132(4) and the application priority tables 133(1) to 133(4) according to the processing state of the machine tool 30. However, the present invention is not limited thereto. For example, in the case of the industrial machine being a robot, the robot controller serving as a control device (not shown) may have a terminal priority table and an application priority table according to the processing state of the robot (not shown).

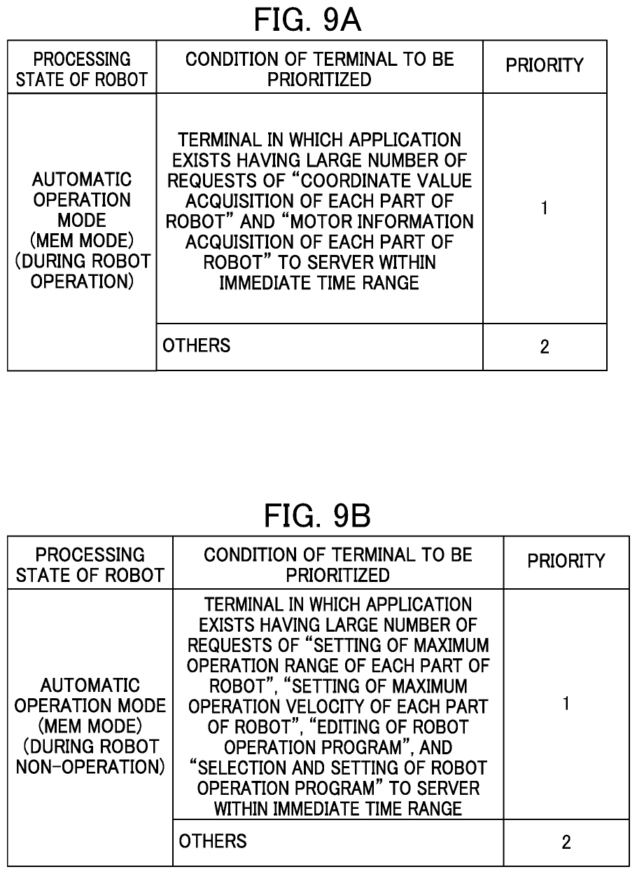

FIG. 9A is a diagram showing an example of a terminal priority table when the processing state of the robot is an automatic operation (MEM) mode (during robot operation).

As shown in FIG. 9A, in the terminal priority table in the automatic operation (MEM) mode (during robot operation), the highest priority “1” is set for a terminal (client 20) in which an application exists having a large number of requests of “coordinate value acquisition of each part of robot” and “motor information acquisition of each part of robot” to the server 110 within an immediate time range as a predetermined period (for example, from the current time to the time one minute before). Furthermore, in the terminal priority table of the automatic operation (MEM) mode (during robot operation), priority “2” may be set for terminals other than the client 20 having priority “1” as “others”.

Herein, “coordinate value acquisition of each part of robot” refers to, for example, a request for monitoring to prevent the arm of a robot, etc. from interfering with peripheral devices. Furthermore, “motor information of each part of robot” refers to, for example, avoid motor failure by monitoring to check whether a load becomes too high.

In other words, high priority “1” is set for the client 20 having the requests of “coordinate value acquisition of each part of robot” and “motor information acquisition of each part of robot” to be conscious during the robot operation most frequently within an immediate time range (for example, from the current time to the time one minute before).

FIG. 9B is a diagram showing an example of a terminal priority table when the processing state of the robot is the automatic operation (MEM) mode (during robot non-operation).

As shown in FIG. 9B, in the terminal priority table in the automatic operation (MEM) mode (during robot non-operation), the highest priority “1” is set for a terminal (client 20) in which an application exists having the large number of requests of “setting of maximum operation range of each part of robot”, “setting of maximum operation velocity of each part of robot”, “editing of robot operation program”, and “selection and setting of robot operation program” to the server 110 within an immediate time range as a predetermined period (for example, from the current time to the time one minute before). Furthermore, in the terminal priority table of the automatic operation (MEM) mode (during robot non-operation), priority “2” may be set for terminals other than the client 20 having priority “1” as “others”.

Herein, “setting of maximum operation range of each part of robot” refers to, for example, a request for a setting which leads to accident prevention. Furthermore, “setting of maximum operation velocity of each part of robot” refers to, for example, a request for minimizing damage even if a collision occurs. Furthermore, “editing of robot operation program” refers to a request for designating and setting the robot operation. Furthermore, “selection and setting of robot operation program” refers to selecting and setting the program for any operation to the robot.

In other words, since various kinds of settings are performed for a robot in the case of being during robot non-operation, high priority “1” is set for the client 20 having a large number of requests of “getting of maximum operation range of each part of robot”, “setting of maximum operation velocity of each part of robot”, “editing of robot operation program”, and “selection and setting of robot operation program” within an immediate time range (for example, from the current time to the time one minute before).

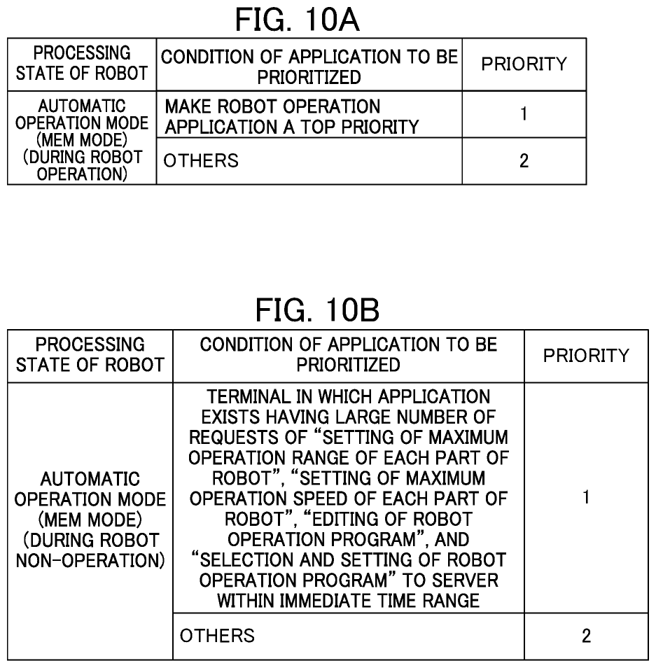

FIG. 10A is a diagram showing an example of an application priority table when the processing state of the robot is in the automatic operation (MEM) mode (during robot operation).

As shown in FIG. 10A, in the application priority table of the automatic operation (MEM) mode (during robot operation), the highest priority “1” is set for “robot operation application.” that operates a robot control device (now shown) as a predetermined application. Furthermore, in the application priority table of the automatic operation (MEM) mode (during robot operation), priority “2” may be set for applications other than “robot operation application” (for example, data logging application, etc.) as “others”.

FIG. 10B is a diagram showing an example of an application priority table when the processing state of the robot is in the automatic operation (MEM) mode (during robot non-operation).

As shown in FIG. 10B, in the application priority table in the automatic operation (MEM) mode (during robot non-operation), high priority “1” is set for an application having the large number of requests of “setting of maximum operation range of each part of robot”, “setting of maximum operation velocity of each part of robot”, “editing of robot operation program”, and “selection and setting of robot operation program” to the server 110 within an immediate time range as a predetermined period (for example, from the current time to the time one minute before). Furthermore, in the application priority table of the automatic operation (MEM) mode (during robot non-operation), priority “2” may be set for applications other than “robot operation application” having priority “1” as “others”.

Although the plurality of terminal priority tables and application priority tables have been exemplified in accordance with the processing state for the robot, these are merely examples, and the present invention is not limited thereto. The user may set the terminal priority tables and the application priority tables as appropriate.

It should be noted that the determination processing of the robot control device (not shown) using the terminal priority tables of FIGS. 9A and 9B and the application priority tables of FIGS. 10A and 10B is the same as that of the numerical control device 10, and thus explanations thereof will be omitted.

It should be noted that each function included in the numerical control device 10 according to an embodiment can be realized by hardware, software or a combination thereof. Here, being realized by software indicates being realized by a computer reading and executing a program. It should be noted that each function may also be realized by an electronic circuit.

The programs can be stored using any of various types of non-transitory computer readable media, and be provided to a computer. The non-transitory computer readable media include various types of tangible storage media. Examples of non-transitory computer readable media include magnetic recording media (e.g., flexible disks, magnetic tapes, hard disk drives), magneto-optical media (e.g., magneto-optical disks), CD-ROM (Read Only Memory), CD-R, CD-R/W, semiconductor memory (e.g., mask ROM, PROM (Programmable ROM), EPROM (Erasable PROM), flash ROM, RAM). The programs may be provided to a computer by using any of various types of transitory computer readable media. Examples of the transitory computer readable media include electric signals, optical signals, and electromagnetic waves. A transitory computer readable medium can provide programs to a computer through a wired communication path such as an electrical cable, an optical fiber, or the like or, a wireless communication path.

It should be noted that the step of writing programs to be recorded on a recording medium includes processing that is performed in a time series manner according to the order, and processing that is performed in a parallel or independent manner even if the processing is not necessarily performed in a time series manner.

In other words, the control device and the control method of the present disclosure may assume various embodiments having the following configuration.

(1) The numerical control device 10 according to the present disclosure relates to a control device 10 that executes processing of processing requests for a machine tool 30 from a plurality of clients 20, the control device 10 including: a priority determination unit 121 configured to determine, in a case in which a plurality of the processing requests is received from the plurality of clients 20, a priority of each of the plurality of clients 20 according to a processing state of the machine tool 30, and a processing switching unit 122 configured to switch an order of processing of each of the plurality of the processing requests based on a priority of each of the plurality of clients 20 determined by the priority determination unit 121.

According to this numerical control device 10, it is possible to reliably execute processing of the clients 20 or the applications to be prioritized according to the processing contents for each processing state for the industrial machine 30, and thus it is possible to suppress the delay of processing to be immediately performed.

(2) The numerical control device (10) according to (1) may further include a terminal priority table 132 configured to store terminal priority information indicating a priority of a client 20 according to a number of requests of processing requests that are set in advance within a predetermined period for each of processing states of the machine tool 30, in which the priority determination unit 121 may determine a priority of each of the plurality of clients 20 based on the terminal priority information according to a processing state of the industrial machine 30.

In this way, it is possible to reliably execute the processing of the clients 20 to be prioritized for each processing state for the machine tool 30, and thus it is possible to suppress the delay of the processing to be performed immediately.

(3) In the numerical control device 10 according to (1) or (2), in which the priority determination unit 121 may determine a priority of an application executed by each of the plurality of clients 20 according to a processing state of the machine tool 30, and in which the processing switching unit 122 may switch an order of processing of each of the plurality of processing requests based on a priority of each of the plurality of clients 20 and a priority of the application.

With such a configuration, the numerical control device 10 is able to reliably execute processing of the clients 20 or the applications to be prioritized according to the processing contents for each processing state for the industrial machine 30, and thus it is possible to suppress the delay of processing to be immediately performed.

(4) The numerical control device 10 according to (3) may further include an application priority table 133 configured to store application priority information indicating a priority of an application according to a number of requests of processing requests that are set in advance in a predetermined period or a predetermined application, for each of processing states of the machine tool 30, in which the priority determination unit 121 may determine a priority of the application based on the application priority information according to a processing state of the machine tool 30.

In this way, it is possible to reliably execute the processing of the clients 20 or the applications to be prioritized for each processing state for the machine tool 30, and thus it is possible to suppress the delay of the processing to be performed immediately.

(5) The numerical control device 10 according to any one of (1) to (4) may further include: a server 110 configured to communicate with each of the plurality of clients 20, and a load monitoring unit 123 configured to monitor at least one load among a processing load in the numerical control device 10, a communication load with each of the plurality of clients 20, and a processing load in the server 110, in which the priority determination unit 121 may determine, in a case in which the load monitored by the load monitoring unit 123 is larger than a predetermined value, a priority of each of the plurality of clients 20 according to at least a processing state of the machine tool 30.

In this way, even when any of the processing load of the numerical control device 10, the communication load between the client 20 and the server 110, and the processing load of the server 110 becomes high, it is possible to reliably execute the processing of the clients 20 or the applications to be prioritized for each processing state of the machine tool 30, and hence, it is possible to suppress the delay of the processing to be immediately performed.

(6) The numerical control device 10 according to any one of (1) to (5), in which the industrial machine may be the machine tool 30, and the control device may be the numerical control device 10.

In so doing, the effects of (1) to (5) can be achieved when the industrial machine is the machine tool 30.

(7) The numerical control device 10 according to any one of (1) to (5), in which the industrial machine may be an industrial robot, and the control device may be a robot control device.

In doing so, the effects of (1) to (5) can be achieved. when the industrial machine is an industrial robot.

(8) A control method according to the present disclosure relates to a control method for executing processing of processing requests for a machine tool 30 from a plurality of clients 20, the method including: determining, in a case in which a plurality of the processing requests is received from the plurality of clients 20, a priority of each of the plurality of clients 20 according to a processing state of the machine tool 30; and switching an order of processing of each of the plurality of processing requests based on a priority of each of the plurality of clients 20.

According to this control method, it is possible to achieve the same effect as (1).

### EXPLANATION OF REFERENCE NUMERALS

1 control system
10 numerical control device
20 client
30 machine tool
110 server
120 control unit
121 priority determination unit
122 processing switching unit
130 storage unit
131 NC data
132(1) to 132(4) terminal priority table
133(1) to 133(4) application priority table

What is claimed is:

1. A control device that executes processing of processing requests for an industrial machine from a plurality of clients, the control device comprising:
a priority determination unit configured to determine, in a case in which a plurality of the processing requests is received from the plurality of clients, a priority of each of the plurality of clients according to a processing state of the industrial machine, and
a processing switching unit configured to switch an order of processing of each of the plurality of the processing requests based on a priority of each of the plurality of clients determined by the priority determination unit.

2. The control device according to claim 1, further comprising a terminal priority table configured to store terminal priority information indicating a priority of a client according to a number of requests of processing requests that are set in advance within a predetermined period for each of processing states of the industrial machine,
wherein the priority determination unit determines a priority of each of the plurality of clients based on the terminal priority information according to a processing state of the industrial machine.

3. The control device according to claim 1,
wherein the priority determination unit determines a priority of an application executed by each of the plurality of clients according to a processing state of the industrial machine, and
wherein the processing switching unit switches an order of processing of each of the plurality of processing requests based on a priority of each of the plurality of clients and a priority of the application.

4. The control device according to claim 3, further comprising an application priority table configured to store application priority information indicating a priority of an application according to a number of requests of processing requests that are set in advance in a predetermined period or a predetermined application, for each of processing states of the industrial machine,
wherein the priority determination unit determines a Priority of the application based on the application priority information according to a processing state of the industrial machine.

5. The control device according to claim 1, further comprising:
a server configured to communicate with each of the plurality of clients, and
a load monitoring unit configured to monitor at least one load among a processing load in the control device, a communication load with each of the plurality of clients, and a processing load in the server,
wherein the priority determination unit determines, in a case in which the load monitored by the load monitoring unit is larger than a predetermined value, a priority of each of the plurality of clients according to at least a processing state of the industrial machine.

6. The control device according to claim 1, wherein the industrial machine is a machine tool, and the control device is a numerical control device.

7. The control device according to claim 1, wherein the industrial machine is an industrial robot, and the control device is a robot control device.

8. A control method for executing processing of processing requests for an industrial machine from a plurality of clients, the method comprising:
determining, in a case in which a plurality of the processing requests is received from the plurality of clients, a priority of each of the plurality of clients according to a processing state of the industrial machine; and
switching an order of processing of each of the plurality of processing requests based on a priority of each of the plurality of clients.
